(19) United States
(12) Patent Application Publication
(10) Pub. No.: US 2012/0268322 A1
(43) Pub. Date: Oct. 25, 2012

(54) GPS POSITIONING SYSTEM, GPS POSITIONING METHOD, AND GPS POSITIONING TERMINAL

(75) Inventor: Makoto Takahashi, Yokosuka-shi (JP)

(73) Assignee: NTT Docomo, Inc., Chiyoda-ku, Tokyo (JP)

(21) Appl. No.: 13/391,058

(22) PCT Filed: Jul. 9, 2010
(86) PCT No.: PCT/JP2010/061656

§ 371 Date: Mar. 27, 2012

(30) Foreign Application Priority Data
Aug. 17, 2009 (JP) 2009-188499

(51) Int. Cl. G01S 19/25

(52) U.S. Cl. 342/357.64

(57) ABSTRACT

A GPS positioning system including: a storage unit for storing therein assist data for GPS positioning; a determination unit for determining whether the stored assist data stored in the storage unit is valid or invalid; an autonomous positioning unit for, when the stored assist data is determined to be valid, based on the stored assist data determined to be valid without communicating with a base station, performing GPS positioning; an A-GPS positioning unit for, when the stored assist data is determined to be invalid, based on assist data acquired by communication with the base station, performing GPS positioning; and an updating unit for, when the GPS positioning succeeds, based on a result of the positioning, updating the stored assist data and, when the GPS positioning fails, based on the assist data acquired by communication with the base station, updating the stored assist data.

### TECHNICAL FIELD

The present invention relates to a GPS positioning system, a GPS positioning method, and a GPS positioning terminal.

### BACKGROUND ART

Examples of a technique in which a terminal independently performs global positioning system (GPS) positioning include autonomous positioning. The autonomous positioning is used, for example, in a positioning device without a communication function such as car navigation, and positioning modes thereof are classified into cold start and hot start. In the cold start, without using information for GPS positioning (for example, information such as an initial position, time, and an orbits of a satellite), by obtaining information such as the orbit of the satellite and time by decoding a signal received from a GPS satellite and, based on the information, for example, determining a distance between the satellite and a location to be measured on the basis of time difference between transmission and reception and the velocity of light, and performing these processes on three satellites, if the locations of the three satellites are known, it is possible to determine one position on the ground on the basis of the locations of these satellites and the distances to the respective satellites. In addition, by obtaining information from still another satellite, it is possible to improve the accuracy of time information, and also improve the positioning accuracy. However, the cold start requires decoding signals received from the satellites to obtain information, and thus has problems in that, in order to perform positioning successfully, its use is limited to an environment where it is possible to capture high-intensity signals from a plurality of satellites and, even when the positioning succeeds, it takes significant time to complete the positioning. In contrast, the hot start, by storing information for GPS positioning in advance and performing the positioning using the information, does not require a decoding process of signals to obtain the information, making it possible to shorten time required for positioning effectively.

In such autonomous positioning, in order to obtain information for GPS positioning, it is necessary to perform the cold start once to collect information (perform the positioning successfully). Once obtaining the information for GPS positioning, then, in the hot start, based on location information and time information obtained, it is possible to continue to update the information for GPS positioning. However, once the positioning fails, it is impossible to update the information for GPS positioning, and the freshness thereof deteriorates over time, which creates a need to perform positioning in cold start again. In addition, when the GPS positioning fails, there is a problem in that it is impossible to obtain any information on the current position and thus the current position of the terminal becomes completely unknown.

On the other hand, examples of a method, with a terminal coordinated with a network (NW), for performing positioning while receiving assistance of the NW include network-assisted GPS positioning (hereinafter, referred to as “A-GPS positioning”) (see Patent Literature 1, for example). The A-GPS is a system that obtains the above-described information for GPS positioning from a base station of a cellular phone. The A-GPS, when performing positioning, acquires “assist data” including the information for GPS positioning from the base station and performs positioning using the assist data. Acquiring assist data from a base station on a NW is faster than decoding signals from satellites and then obtaining information for GPS positioning. Accordingly, the A-GPS positioning can perform positioning at a higher speed than the cold start of the autonomous positioning and with comparable accuracy. In addition, even when the GPS positioning itself fails, it is possible to measure the approximate position on the basis of a positional relationship with the base station using the assist data. It should be noted that, regarding the positioning, the case of performing it with a terminal that receives signals from satellites and the case of sending the signals to a NW and calculating a result of the positioning on the NW can be considered, and it is acceptable to adopt either of the cases.

### CITATIONT LIST

### Patent Literature

[Patent Literature 1] Japanese Patent Application Laid-Open Publication No. 2003-43127

### SUMMARY OF INVENTION

### Technical Problem

However, in the A-GPS positioning, whenever performing the positioning, communication for acquiring assist data from a base station occurs. In addition, after acquiring the assist data, during a period when performing the GPS positioning, it is unforgivable to disconnect the communication on the basis of standard specification. Furthermore, when performing the A-GPS positioning every time, a C-Plane connection has to be established for each time, and thus a C-Plane bearer needs to be maintained from start to completion of the positioning. Accordingly, a problem arises in that the power consumption for communication increases and also the traffic load on network facilities increases.

Therefore, the present invention is made in view of the foregoing, and aims to provide a GPS positioning system, a GPS positioning method, and a GPS positioning terminal that can perform GPS positioning with high accuracy and efficiency and further at high speed.

### Solution to Problem

To solve the above-described problems, a GPS positioning system according to the present invention is a GPS positioning system including a GPS positioning terminal and a server on a network, and includes storage means for storing therein assist data for GPS positioning; determination means for determining whether stored assist data that is the assist data stored in the storage means is valid or invalid; non-communication-type positioning means for, when the stored assist data is determined to be valid, based on the stored assist data determined to be valid without communicating with the server, performing GPS positioning; communication-type positioning means for, when the stored assist data is determined to be invalid, based on assist data acquired by communication with the server, performing GPS positioning; and updating means for, when the GPS positioning by the non-communication-type positioning means or the communication-type positioning means succeeds, based on a result of the positioning, updating the stored assist data and storing the resulting assist data in the storage means and, when the GPS positioning by the non-communication-type positioning means or the communication-type positioning means fails, based on the assist data acquired by communication with the server, updating the stored assist data and storing the resulting assist data in the storage means.

In addition, a GPS positioning method according to the present invention is a GPS positioning method performed in a GPS positioning system including a GPS positioning terminal and a server on a network and, with assist data for GPS positioning stored in storage means, includes a determination step of, by determination means, determining whether stored assist data that is the assist data stored in the storage means is valid or invalid; a non-communication-type positioning step of, by non-communication-type positioning means, when the stored assist data is determined to be valid, based on the stored assist data determined to be valid without communicating with the server, performing GPS positioning; a communication-type positioning step of, by communication-type positioning means, when the stored assist data is determined to be invalid, based on assist data acquired by communication with the server, performing GPS positioning; and an updating step of, by updating means, when the GPS positioning by the non-communication-type positioning means or the communication-type positioning means succeeds, based on a result of the positioning, updating the stored assist data and storing the resulting assist data in the storage means and, when the GPS positioning by the non-communication-type positioning means or the communication-type positioning means fails, based on the assist data acquired by communication with the server, updating the stored assist data and storing the resulting assist data in the storage means.

In addition, a GPS positioning terminal according to the present invention includes storage means for storing therein assist data for GPS positioning; determination means for determining whether stored assist data that is the assist data stored in the storage means is valid or invalid; non-communication-type positioning means for, when the stored assist data is determined to be valid, based on the stored assist data determined to be valid without communicating with a server on a network, performing GPS positioning; communication-type positioning means for, when the stored assist data is determined to be invalid, based on assist data acquired by communication with the server, performing GPS positioning; and updating means for, when the GPS positioning by the non-communication-type positioning means or the communication-type positioning means succeeds, based on a result of the positioning, updating the stored assist data and storing the resulting assist data in the storage means and, when the GPS positioning by the non-communication-type positioning means or the communication-type positioning means fails, based on the assist data acquired by communication with the server, updating the stored assist data and storing the resulting assist data in the storage means.

In the GPS positioning system, the GPS positioning method, and the GPS positioning terminal according to the present invention, the determination means determines validity or invalidity of the stored assist data. Depending on this determination, when the stored assist data is valid, without communicating with the server on the network, based on the stored assist data determined to be valid, GPS positioning is performed. Accordingly, it is possible to reduce the number of communications with the server on the network and, without increasing the power consumption for communication or the traffic load on network facilities, it is possible to perform GPS positioning efficiently. On the other hand, because GPS positioning is performed based on the stored assist data determined to be valid, while maintaining high positioning accuracy, compared to cold start of autonomous positioning, for example, GPS positioning at high speed becomes possible.

In addition, according to the present invention, when the stored assist data is determined to be valid and also when determined to be invalid, and further, when GPS positioning succeeds and also when it fails, the updating means updates the stored assist data. By this updating process of the stored assist data, the stored assist data can be determined to be valid in the next positioning, and consequently, it becomes possible in the next positioning for the non-communication-type positioning means to perform GPS positioning on the basis of the stored assist data determined to be valid without communicating with the server on the network. More specifically, in the case of continuously performing positioning, at the first time and when the stored assist data is determined to be invalid, the communication-type positioning means will perform GPS positioning in communication with the server, but in other cases, i.e., in the cases of continuous positioning after the first time (including the case in which the stored assist data is determined to be valid even at the first time), the non-communication-type positioning means can perform GPS positioning using the stored assist data being valid after the updating without communicating with the server on the network, in other words, it becomes possible to maintain a hot start state of the autonomous positioning. Accordingly, it is possible to reduce the number of communications with the server on the network and, without increasing the power consumption for communication or the traffic load on network facilities, it is possible to perform GPS positioning efficiently. On the other hand, because GPS positioning is performed based on the stored assist data determined to be valid by the updating process, in positioning after the first time in the continuous positioning, while maintaining high positioning accuracy, compared to the cold start of the autonomous positioning, for example, GPS positioning at high speed becomes possible.

In addition, in the present invention, occurrence of communication with the server on the network for the updating process of the stored assist data by the updating means is limited to the case in which GPS positioning fails. It is because when GPS positioning succeeds, without separately communicating with the server, based on the result of the positioning that succeeds, the updating process of the stored assist data could be performed. Accordingly, without increasing the number of communications with the server on the network, and also without increasing the power consumption for communication or the traffic load on network facilities, it is possible to continue to maintain the stored assist data as the latest and valid one.

In addition, the present invention preferably includes approximate position calculation means for, when the GPS positioning by the non-communication-type positioning means or the communication-type positioning means fails, calculating an approximate position of the GPS positioning terminal based on the assist data acquired by communication with the server.

According to the present invention, it is possible to avoid the situation that the current position of the terminal becomes completely unknown when GPS positioning fails.

In addition, in the present invention, the update of the stored assist data by the updating means is preferably performed when the GPS positioning terminal moves within an area and when it moves over areas.

According to the present invention, regardless of the movement range of the terminal, the updating process of the stored assist data by the updating means is performed. Accordingly, it becomes possible, in positioning after the first time when performing continuous positioning, regardless of the movement range of the terminal, to perform GPS positioning using the stored assist data being valid after the updating without communicating with the server on the network.

In addition, in the present invention, it is preferable that the non-communication-type positioning means perform autonomous positioning, and the communication-type positioning means perform network-assisted GPS positioning.

The present invention is particularly effective when the non-communication-type positioning means performs the autonomous positioning and also the communication-type positioning means performs the network-assisted GPS positioning.

### Advantageous Effects of Invention

According to the present invention, it is possible to provide a GPS positioning system, a GPS positioning method, and a GPS positioning terminal that can perform GPS positioning with high accuracy and efficiency and further at high speed.

### BRIEF DESCRIPTION OF DRAWINGS

FIG. 1 is a block schematic diagram of a GPS positioning system 1.

FIG. 2 is a hardware block diagram of a terminal 30.

FIG. 3 is a flowchart illustrating operations of the GPS positioning system 1.

FIG. 4 is a diagram illustrating steps S1, S2, S3, S4, and S5 of FIG. 3 in a sequence diagram.

FIG. 5 is a diagram illustrating steps S1, S2, S3, and S5 of FIG. 3 in a sequence diagram.

FIG. 6 is a diagram illustrating steps S1, S6, S7, and S5 of FIG. 3 in a sequence diagram.

FIG. 7 is a diagram illustrating steps S1, S6, S7, S8, and S5 of FIG. 3 in a sequence diagram.

FIG. 8 is a diagram for illustrating one example of an effect of the present embodiment.

### REFERENCE SIGNS LIST

1 . . . GPS positioning system, 10 . . . base station, 20 . . . network, 30 . . . terminal, 31 . . . communication unit, 32 . . . A-GPS positioning unit, 33 . . . autonomous positioning unit, 34 . . . approximate position calculation unit, 35 . . . determination unit, 36 . . . storage unit, 37 . . . updating unit

### Description of Embodiments

Preferred embodiments of a GPS positioning system, a GPS positioning method, and a GPS positioning terminal according to the present invention will be described in detail hereinafter with reference to the drawings. It should be noted that like reference signs are given to like elements in the description of the drawings, and redundant explanations are omitted.

(Overall Structure of GPS Positioning System 1)

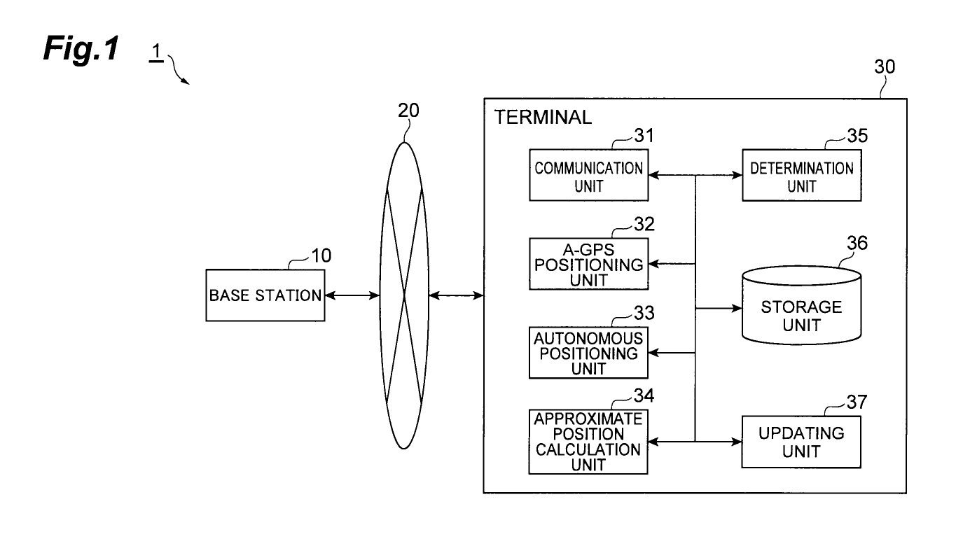

To begin with, a structure of a GPS positioning system 1 according to an embodiment of the present invention will be described with reference to FIG. 1. FIG. 1 is a block schematic diagram of the GPS positioning system 1. As depicted in FIG. 1, the GPS positioning system 1 is structured with a base station 10 (corresponding to a “server” in the claims) and a terminal 30 (corresponding to a “GPS positioning terminal” in the claims), and the base station 10 and the terminal 30 are connected to each other by a network 20.

(Structure of Base Station 10)

The base station 10 is a device for relaying communication connection to the terminal 30 with the network. The base station 10, although not depicted, physically structured as a conventional computer system including a CPU, a main storage such as a ROM and a RAM, an input device such as a keyboard and a mouse, an output device such as a display, a communication module such as a network card for performing data transmission to and reception from the terminal 30, and an auxiliary storage such as a hard disk. Each function of the base station 10 is implemented by loading predetermined computer software into hardware such as the CPU, the ROM, and the RAM to operate the input device, the output device and the communication module under control of the CPU, and also by reading and writing data in the main storage and the auxiliary storage. In particular, in the storages of the base station 10, assist data is stored, and the assist data, as described later, is used when the assist data stored in the terminal 30 is invalid, for example.

(Structure of Terminal 30)

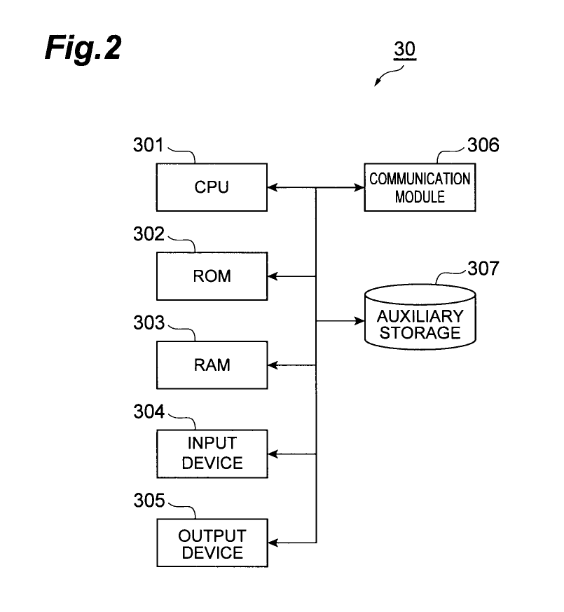

Subsequently, the terminal 30 will be described in detail. FIG. 2 is a hardware block diagram of the terminal 30. As depicted in FIG. 2, the terminal 30 is physically configured to include a CPU 301, a ROM 302 and a RAM 303 being main storages, an input device 304 such as an operation button, an output device 305 such as an LCD or an organic EL display, a communication module 306 that performs data transmission to and reception from the base station 10, and an auxiliary storage 307 such as a memory device. Each function of the terminal 30 described later is implemented by loading predetermined software into hardware such as the CPU 301, the ROM 302, and the RAM 303 to operate the input device 304, the output device 305, and the communication module 306 under control of the CPU 301, and also by reading and writing data in the main storages 302 and 303, and the auxiliary storage 307.

Referring back to FIG. 1, the terminal 30 is functionally configured to include a communication unit 31, an A-GPS positioning unit 32 (corresponding to “communication-type positioning means” in the claims), an autonomous positioning unit 33 (corresponding to “non-communication-type positioning means” in the claims), an approximate position calculation unit 34 (corresponding to “approximate position calculation means” in the claims), a determination unit 35 (corresponding to “determination means” in the claims), a storage unit 36 (corresponding to “storage means” in the claims), and an updating unit 37 (corresponding to “updating means” in the claims).

The storage unit 36 is a unit that stores therein assist data for GPS positioning. In this assist data, for example, drift information of a clock for positioning, satellite navigation data, approximate position information, and initial time accuracy are included. Hereinafter, assist data stored in the storage unit 36 is referred to as “stored assist data”, and assist data stored in the base station 10 is referred to as “NW assist data”. “Stored assist data” in the claims corresponds to the “stored assist data” stored in the storage unit 36, and “assist data acquired by communication with the server” in the claims corresponds to the “NW assist data” stored in the base station 10.

The determination unit 35 is a unit that determines whether the stored assist data is valid or invalid. A determination method of the determination unit 35 is not particularly limited and, for example, it is acceptable to check time information included in the stored assist data and, if a certain time period has passed after the present time, determine the stored assist data to be invalid and, if not, determine it to be valid. The determination unit 35, when the stored assist data is determined to be valid, reports this determination to the autonomous positioning unit 33 and, when the stored assist data is determined to be invalid, reports this determination to the A-GPS positioning unit 32 and the communication unit 31.

The autonomous positioning unit 33, when the stored assist data is determined to be valid and this determination is reported by the determination unit 35, based on the stored assist data determined to be valid without communicating with the base station 10, performs GPS positioning. In other words, the autonomous positioning unit 33, when the stored assist data is valid, performs autonomous positioning in hot start. In addition, the autonomous positioning unit 33, when the autonomous positioning fails, reports this failure to the approximate position calculation unit 34 and the communication unit 31.

The A-GPS positioning unit 32, when the stored assist data is determined to be invalid and this determination is reported by the determination unit 35, based on NW assist data acquired by communication with the base station 10, performs GPS positioning. In other words, the A-GPS positioning unit 32, when the stored assist data is invalid, performs network-assisted GPS positioning. The communication unit 31, when the stored assist data is determined to be invalid and this determination is reported by the determination unit 35, requests the base station 10 to transmit the NW assist data, receives the NW assist data transmitted by the base station 10 in response to the request, and outputs it to the A-GPS positioning unit 32. In addition, the A-GPS positioning unit 32, when the A-GPS positioning fails, reports this failure to the approximate position calculation unit 34 and the communication unit 31.

The updating unit 37 is a unit that updates the stored assist data and stores the stored assist data thus updated in the storage unit 36. More specifically, the updating unit 37, when the GPS positioning by the autonomous positioning unit 33 or the A-GPS positioning unit 32 succeeds, based on the positioning result, updates the stored assist data and stores the resulting assist data in the storage unit 36. In addition, the updating unit 37, when the GPS positioning by the autonomous positioning unit 33 or the A-GPS positioning unit 32 fails, based on the NW assist data acquired by communication with the base station 10, updates the stored assist data and stores the resulting assist data in the storage unit 36. The communication unit 31, when the failure of the autonomous positioning or the A-GPS positioning is reported by the autonomous positioning unit 33 or the A-GPS positioning unit 32, requests the base station 10 to transmit the NW assist data, receives the NW assist data transmitted by the base station 10 in response to the request, and outputs it to the updating unit 37. It should be noted that, in the case of the A-GPS positioning failure, the communication unit 31 has already received the NW assist data for performing A-GPS positioning, and thus may invoke this NW assist data. In addition, the updating process of the stored assist data by the updating unit 37 is performed regardless of whether the terminal moves within an area or moves over areas, or whether the terminal does not move. The “area” herein is, for example, an area that the base station 10 covers, such as a cell.

The approximate position calculation unit 34, when the GPS positioning by the autonomous positioning unit 33 or the A-GPS positioning unit 32 fails, based on the NW assist data acquired by communication with the base station 10, calculates an approximate position of the terminal 30. The communication unit 31, when the failure of the autonomous positioning or the A-GPS positioning is reported by the autonomous positioning unit 33 or the A-GPS positioning unit 32, requests the base station 10 to transmit the NW assist data, receives the NW assist data transmitted by the base station 10 in response to the request, and outputs it to the approximate position calculation unit 34. It should be noted that, in the case of the A-GPS positioning failure, the communication unit 31 has already received the NW assist data for performing A-GPS positioning, and thus may invoke this NW assist data.

(Operations of GPS Positioning System 1)

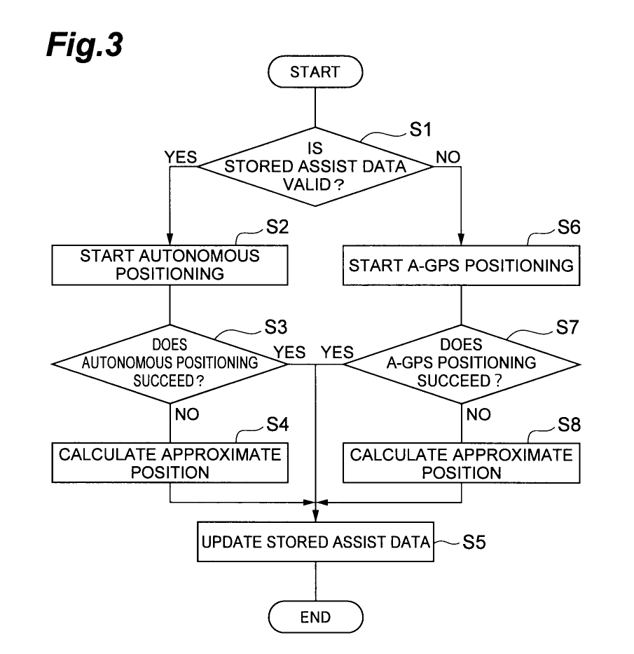

Subsequently, operations (corresponding to a “GPS positioning method” in the claims) executed by the GPS positioning system 1 will be described with reference to FIG. 3. FIG. 3 is a flowchart illustrating the operations of the GPS positioning system 1. In the following description, the operations of the GPS positioning system 1 are divided into four cases and each of them will be explained. The four cases are when the stored assist data is valid and the autonomous positioning fails (Operations of GPS Positioning System 1, First Case), when the stored assist data is valid and the autonomous positioning succeeds (Operations of GPS Positioning System 1, Second Case), when the stored assist data is invalid and the A-GPS positioning succeeds (Operations of GPS Positioning System 1, Third Case), and when the stored assist data is invalid and the A-GPS positioning fails (Operations of GPS Positioning System 1, Fourth Case).

(Operations of GPS Positioning System 1, First Case)

Initially, the determination unit 35 determines whether the stored assist data is valid or invalid (step S1, corresponding to a “determination step” in the claims).

Next, the autonomous positioning unit 33, when the stored assist data is determined to be valid at step S1 and this determination is reported by the determination unit 35 (YES at step S1), without communicating with the base station 10, based on the stored assist data determined to be valid, performs GPS positioning (i.e., autonomous positioning in hot start) (step S2, corresponding to a “non-communication-type positioning step” in the claims).

Next, whether the autonomous positioning at step S2 succeeds or fails is determined (step S3) and, when it fails (NO at step S3), the approximate position calculation unit 34, based on NW assist data acquired by communication with the base station 10, calculates an approximate position of the terminal 30 (step S4).

Next, the updating unit 37, based on the NW assist data acquired by communication with the base station 10, updates the stored assist data and stores the resulting assist data in the storage unit 36 (step S5, corresponding to a “updating step” in the claims).

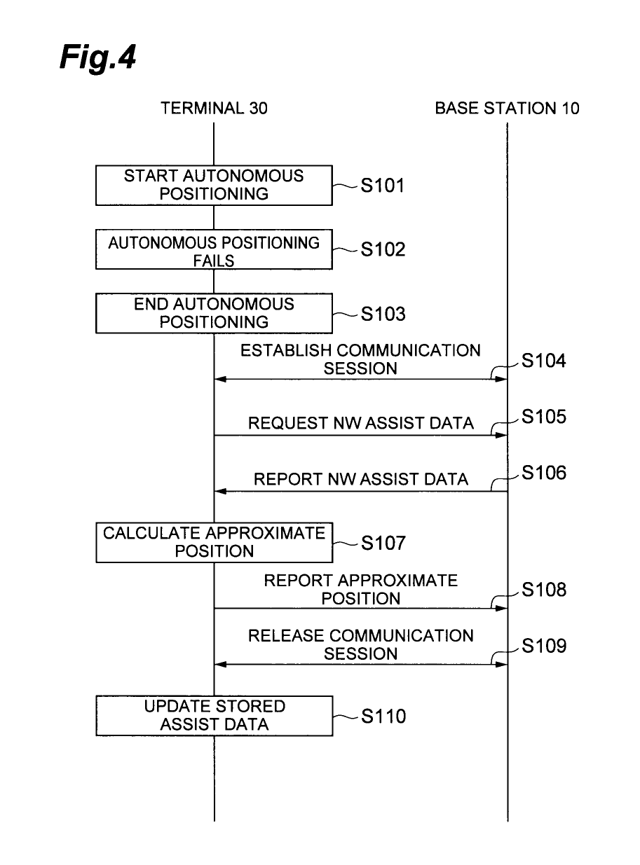

FIG. 4 is a diagram illustrating the foregoing operations (steps S1, S2, S3, S4, and S5) in a sequence diagram. As depicted in FIG. 4, the stored assist data is determined to be valid initially, and autonomous positioning in hot start is performed by the autonomous positioning unit 33, but the autonomous positioning fails (steps S101, S102, and S103). In this case, the communication unit 31 establishes a communication session with the base station 10 (step S104), requests the base station 10 to transmit NW assist data (step S105), and receives the NW assist data reported by the base station 10 in response to the request (step S106). Next, the communication unit 31 outputs the NW assist data thus received to the approximate position calculation unit 34 and the updating unit 37. Next, the approximate position calculation unit 34 calculates an approximate position of the terminal 30 on the basis of the NW assist data (step S107), and reports the approximate position thus calculated to the base station 10 (step S108), and then the communication session is released (step S109). Next, the updating unit 37 updates the stored assist data on the basis of the NW assist data received at step S106 and stores the resulting assist data in the storage unit 36 (step S110).

(Operations of GPS Positioning System 1, Second Case)

Referring back to FIG. 3, initially, the validity of the stored assist data is determined by the determination unit 35 (step S1, corresponding to the “determination step” in the claims) and, when the stored assist data is valid (YES at step S1), the autonomous positioning unit 33 performs autonomous positioning in hot start (step S2, corresponding to the “non-communication-type positioning step” in the claims).

Next, whether the autonomous positioning at step S2 succeeds or fails is determined (step S3) and, when it succeeds (YES at step S3), the updating unit 37 updates the stored assist data on the basis of the positioning result of the autonomous positioning that succeeds, and stores the resulting assist data in the storage unit 36 (step S5, corresponding to the “updating step” in the claims).

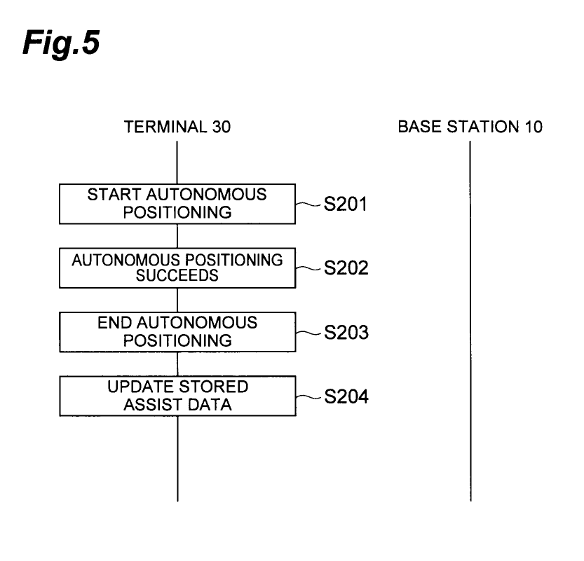

FIG. 5 is a diagram illustrating the foregoing operations (steps S1, S2, S3, and S5) in a sequence diagram. As depicted in FIG. 5, the stored assist data is determined to be valid, autonomous positioning in hot start is performed by the autonomous positioning unit 33, and the autonomous positioning succeeds (steps S201, S202, and S203). In this case, without communication with the base station 10 by the communication unit 31, the updating process of the stored assist data is performed by the updating unit 37. In this updating process, the positioning result of the autonomous positioning acquired within the terminal is used (step S204).

(Operations of GPS Positioning System 1, Third Case)

Referring back to FIG. 3, initially, the determination unit 35 determines whether the stored assist data is valid or invalid (step S1, corresponding to the “determination step” in the claims).

Next, the A-GPS positioning unit 32, when the stored assist data is determined to be invalid at step S1 and this determination is reported by the determination unit 35 (NO at step S1), based on NW assist data acquired by communication with the base station 10, performs GPS positioning (i.e., network-assisted GPS positioning) (step S6, corresponding to a “communication-type positioning step” in the claims).

Next, whether the A-GPS positioning at step S6 succeeds or fails is determined (step S7) and, when it succeeds (YES at step S7), the updating unit 37 updates the stored assist data on the basis of the positioning result of the A-GPS positioning that succeeds, and stores the resulting assist data in the storage unit 36 (step S5, corresponding to the “updating step” in the claims).

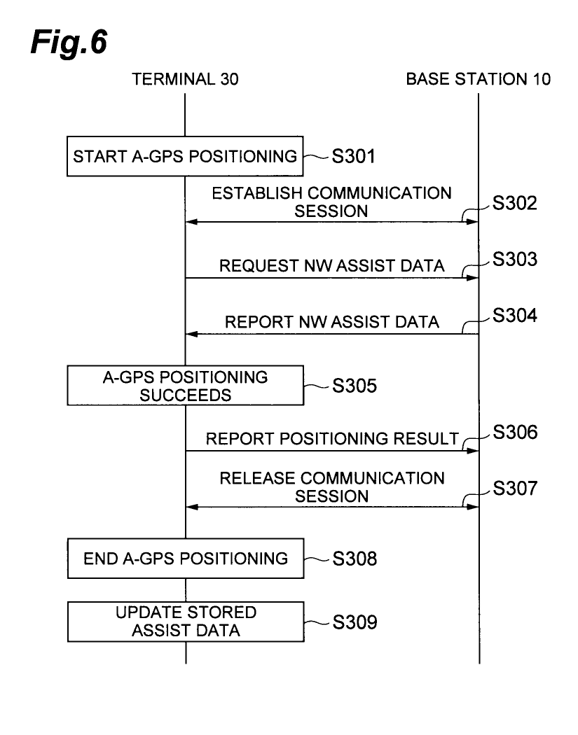

FIG. 6 is a diagram illustrating the foregoing operations (steps S1, S6, S7, and S5) in a sequence diagram. As depicted in FIG. 6, the stored assist data is initially determined to be invalid, and A-GPS positioning by the A-GPS positioning unit 32 is started (step S301). To perform the A-GPS positioning, the communication unit 31 establishes a communication session with the base station 10 (step S302), requests the base station 10 to transmit NW assist data (step S303), and receives the NW assist data reported by the base station 10 in response to the request (step S304). Next, the communication unit 31 outputs the NW assist data thus received to the A-GPS positioning unit 32.

Next, the A-GPS positioning unit 32 performs the A-GPS positioning on the basis of the NW assist data received at step S304, and this A-GPS positioning succeeds (step S305). Then, the A-GPS positioning unit 32 reports the success of the A-GPS positioning to the communication unit 31, and the communication unit 31 reports this positioning result to the base station 10 (step S306). Next the communication session is released (step S307), and the A-GPS positioning ends (step S308).

Next, the updating unit 37, based on the positioning result of the A-GPS positioning that succeeds at step S305, updates the stored assist data, and stores the resulting assist data in the storage unit 36 (step S309).

(Operations of GPS Positioning System 1, Fourth Case)

Referring back to FIG. 3, initially, the determination unit 35 determines whether the stored assist data is valid or invalid (step S1, corresponding to the “determination step” in the claims).

Next, the A-GPS positioning unit 32, when the stored assist data is determined to be invalid at step S1 and this determination is reported by the determination unit 35 (NO at step S1), based on NW assist data acquired by communication with the base station 10, performs GPS positioning (i.e., network-assisted GPS positioning) (step S6, corresponding to the “communication-type positioning step” in the claims).

Next, whether the A-GPS positioning at step S6 succeeds or fails is determined (step S7) and, when it fails (NO at step S7), the approximate position calculation unit 34, based on the NW acquired by communication with the base station 10, calculates an approximate position of the terminal 30 (step S8).

Next, the updating unit 37, based on the NW assist data acquired by communication with the base station 10, updates the stored assist data and stores the resulting assist data in the storage unit 36 (step S6, corresponding to the “updating step” in the claims).

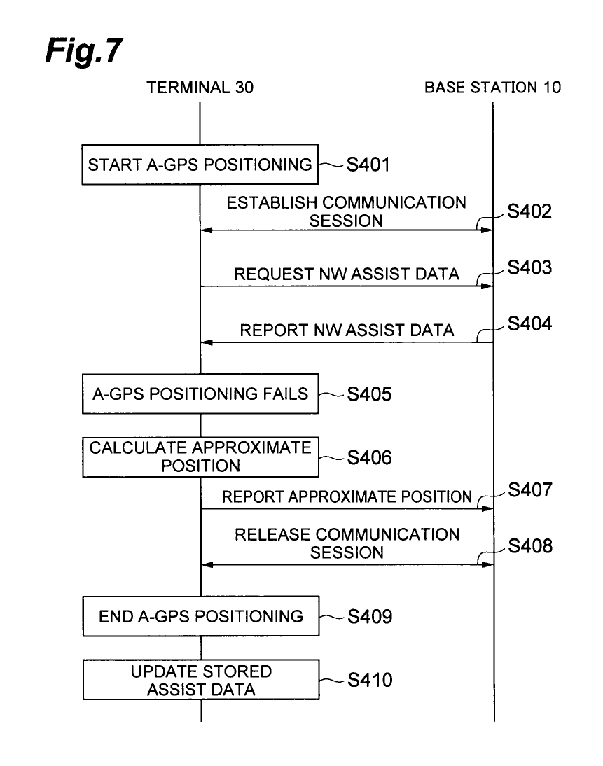

FIG. 7 is a diagram illustrating the foregoing operations (steps S1, S6, S7, S8, and S5) in a sequence diagram. As depicted in FIG. 7, the stored assist data is initially determined to be invalid, and A-GPS positioning by the A-GPS positioning unit 32 is started (step S401). To perform the A-GPS positioning, the communication unit 31 establishes a communication session with the base station 10 (step S402), requests the base station 10 to transmit NW assist data (step S403), and receives the NW assist data reported by the base station 10 in response to the request (step S404). Next, the communication unit 31 outputs the NW assist data thus received to the A-GPS positioning unit 32.

Next, the A-GPS positioning unit 32 performs the A-GPS positioning on the basis of the NW assist data received at step S404, but the A-GPS positioning fails (step S405). Then, the A-GPS positioning unit 32 reports the failure of the A-GPS positioning to the communication unit 31, and the communication unit 31 outputs the NW assist data received at step S404 to the approximate position calculation unit 34 and the updating unit 37.

Next, the approximate position calculation unit 34 calculates an approximate position of the terminal on the basis of the NW assist data input by the communication unit 31 (step S406), and reports the approximate position to the base station 10 (step S407), and then the communication session is released (step S408), and the A-GPS positioning ends (step S409).

Next, the updating unit 37 updates the stored assist data on the basis of the NW assist data input by the communication unit 31, and stores the resulting assist data in the storage unit 36 (step S110). Alternatively, the updating unit 37 may update the stored assist data on the basis of the approximate position calculated by the approximate position calculation unit 34 at step S406.

(Functions and Effects of Present Embodiment)

Subsequently, functions and effects of the GPS positioning system 1 according to the present embodiment will be described. According to the embodiment described above, the determination unit 35 determines validity or invalidity. Depending on this determination, when the stored assist data is valid, without communicating with the base station 10, based on the stored assist data determined to be valid, GPS positioning is performed. Accordingly, it is possible to reduce the number of communications with the base station 10 and, without increasing the power consumption for communication or the traffic load on network facilities, it is possible to perform GPS positioning efficiently. On the other hand, because GPS positioning is performed based on the stored assist data determined to be valid, while maintaining high positioning accuracy, compared to cold start of autonomous positioning, for example, GPS positioning at high speed becomes possible.

In addition, according to the present embodiment, when the stored assist data is determined to be valid and also when determined to be invalid, and further, when GPS positioning succeeds and also when it fails, the updating unit 37 updates the stored assist data. By this updating process of the stored assist data, the stored assist data can be determined to be valid in the next positioning, and consequently, it becomes possible in the next positioning for the autonomous positioning unit 33 to perform GPS positioning on the basis of the stored assist data determined to be valid without communicating with the base station 10. More specifically, in the case of continuously performing positioning, at the first time and when the stored assist data is determined to be invalid, the A-GPS positioning unit 32 will perform GPS positioning in communication with the base station 10, but in other cases, i.e., in the cases of continuous positioning after the first time (including the case in which the stored assist data is determined to be valid even at the first time), the autonomous positioning unit 33 can perform GPS positioning using the stored assist data being valid after the updating without communicating with the base station 10, in other words, it becomes possible to maintain a hot start state of the autonomous positioning. Accordingly, it is possible to reduce the number of communications with the base station 10 and, without increasing the power consumption for communication or the traffic load on network facilities, it is possible to perform GPS positioning efficiently. On the other hand, because GPS positioning is performed based on the stored assist data determined to be valid by the updating process, in positioning after the first time in the continuous positioning, while maintaining high positioning accuracy, compared to the cold start of the autonomous positioning, for example, GPS positioning at high speed becomes possible.

In addition, in the present embodiment, occurrence of communication with the base station 10 for the updating process of the stored assist data by the updating unit 37 is limited to the case in which GPS positioning by the autonomous positioning unit 33 or the A-GPS positioning unit 32 fails (but when A-GPS positioning fails, the NW assist data already received can be invoked). It is because when GPS positioning succeeds, without separately communicating with the base station 10, based on the result of the positioning that succeeds, the updating process of the stored assist data could be performed. Accordingly, without increasing the number of communications with the base station 10, and also without increasing the power consumption for communication or the traffic load on network facilities, it is possible to continue to maintain the stored assist data as the latest and valid one.

In addition, according to the present embodiment, when GPS positioning by the autonomous positioning unit 33 or the A-GPS positioning unit 32 fails, the approximate position calculation unit 34, based on the NW assist data acquired by communication with the base station 10, calculates an approximate position of the terminal 30. Accordingly, it is possible to avoid the situation that the current position of the terminal 30 becomes completely unknown when GPS positioning fails.

In addition, according to the present embodiment, regardless of the movement range of the terminal 30, the updating process of the stored assist data by the updating unit 37 is performed. Accordingly, it becomes possible, in positioning after the first time when performing continuous positioning, regardless of the movement range of the terminal 30, to perform GPS positioning using the stored assist data being valid after the updating without communicating with the base station 10.

The present embodiment described above, for example, in the case of periodically and automatically measuring position information of a user (mobile terminal), having the user use the positioning result in various applications, and providing the user with services, is suitably applicable. Specific examples of the services that are assumed include a service of delivers pinpoint weather information or event information in a city on the basis of the position information of the user via push technology, and an action support service of announcing the last train time information of the nearest station.

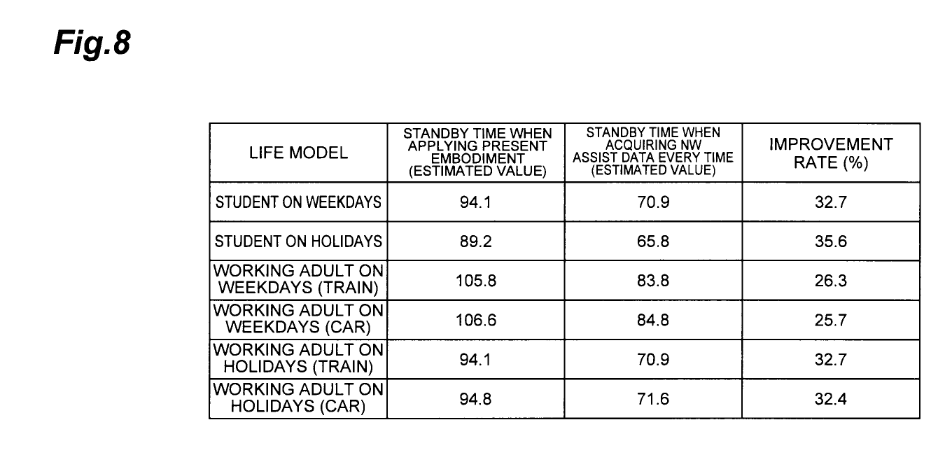

Accordingly, the present inventors simulated behavioral modeling of “performing GPS positioning for persons who move for eight hours a day every five minutes during their movement” as an actual example to which the present embodiment is applied and estimated standby time of their terminals. FIG. 8 is a diagram illustrating a result of the estimation. As depicted in FIG. 8, in this estimation, to six types of life models, estimated values of standby time when applying the present embodiment and the estimated values of standby time when acquiring NW assist data every time were compared, and improvement rates thereof were calculated. As depicted in FIG. 8, in the case of a student on holidays, the estimated value of standby time when applying the present embodiment was 89.2 hours, and the estimated value of standby time when acquiring NW assist data every time was 65.8 hours. Therefore, the improvement rate reached 35.6%. Also, in the case of a working adult on weekdays who moves by car, the improvement rate of which was lowest, the improvement rate of 25.7% could be obtained.

The preferred embodiments according to the present invention have been described above, but it goes without saying that the present invention is not limited to the above-described embodiments. For example, in the above-described embodiments, the A-GPS positioning unit 32 and the autonomous positioning unit 33 are configured as separate GPS positioning modules, but without being limited to this, it is acceptable to configure the A-GPS positioning unit 32 and the autonomous positioning unit 33 as one GPS positioning module (hereinafter, referred to as an “integrated GPS positioning module”), for example. When the stored assist data is determined to be invalid, the integrated GPS positioning module operates as the A-GPS positioning unit 32 and, based on the NW assist data acquired by communication with the base station 10, performs GPS positioning. In addition, when the stored assist data is determined to be valid, the integrated GPS positioning module operates as the autonomous positioning unit 33 and, based on the stored assist data determined to be valid without communication with the base station 10, performs GPS positioning. It should be noted that the integrated GPS positioning module corresponds to both of the “non-communication-type positioning means” and the “communication-type positioning means” in the claims.

### INDUSTRIAL APPLICABILITY

The present invention provides a GPS positioning system, a GPS positioning method, and a GPS positioning terminal that can perform GPS positioning with high accuracy and efficiency and further at high speed.

1-6. (canceled)

7: A GPS positioning system including a GPS positioning terminal and a server on a network, the GPS positioning system comprising:
a storage unit for storing therein assist data for GPS positioning;
a determination unit for determining whether stored assist data that is the assist data stored in the storage unit is valid or invalid;
a non-communication-type positioning unit for, when the stored assist data is determined to be valid, based on the stored assist data determined to be valid without communicating with the server, performing GPS positioning;
a communication-type positioning unit for, when the stored assist data is determined to be invalid, based on assist data acquired by communication with the server, performing GPS positioning; and
an updating unit for, when the GPS positioning by the non-communication-type positioning unit or the communication-type positioning unit succeeds, based on a result of the positioning, updating the stored assist data and storing the resulting assist data in the storage unit and, when the GPS positioning by the non-communication-type positioning unit or the communication-type positioning unit fails, based on the assist data acquired by communication with the server, updating the stored assist data and storing the resulting assist data in the storage unit.

8: The GPS positioning system according to claim 7, further comprising an approximate position calculation unit for, when the GPS positioning by the non-communication-type positioning unit or the communication-type positioning unit fails, calculating an approximate position of the GPS positioning terminal based on the assist data acquired by communication with the server.

9: The GPS positioning system according to claim 7, wherein the update of the stored assist data by the updating unit is performed when the GPS positioning terminal moves within an area and when the GPS positioning terminal moves over areas.

10: The GPS positioning system according to claim 8, wherein the update of the stored assist data by the updating unit is performed when the GPS positioning terminal moves within an area and when the GPS positioning terminal moves over areas.

11: The GPS positioning system according to claim 7, wherein the non-communication-type positioning unit performs autonomous positioning, and the communication-type positioning unit performs network-assisted GPS positioning.

12: The GPS positioning system according to claim 8, wherein the non-communication-type positioning unit performs autonomous positioning, and the communication-type positioning unit performs network-assisted GPS positioning.

13: The GPS positioning system according to claim 9, wherein the non-communication-type positioning unit performs autonomous positioning, and the communication-type positioning unit performs network-assisted GPS positioning.

14: The GPS positioning system according to claim 10, wherein the non-communication-type positioning unit performs autonomous positioning, and the communication-type positioning unit performs network-assisted GPS positioning.

15: A GPS positioning method performed in a GPS positioning system including a GPS positioning terminal and a server on a network and, with assist data for GPS positioning stored in a storage unit, the GPS positioning method comprising:
a determination step of, by a determination unit, determining whether stored assist data that is the assist data stored in the storage unit is valid or invalid;
a non-communication-type positioning step of, by a non-communication-type positioning unit, when the stored assist data is determined to be valid, based on the stored assist data determined to be valid without communicating with the server, performing GPS positioning;
a communication-type positioning step of, by a communication-type positioning unit, when the stored assist data is determined to be invalid, based on assist data acquired by communication with the server, performing GPS positioning; and
an updating step of, by an updating unit, when the GPS positioning by the non-communication-type positioning unit or the communication-type positioning unit succeeds, based on a result of the positioning, updating the stored assist data and storing the resulting assist data in the storage unit and, when the GPS positioning by the non-communication-type positioning unit or the communication-type positioning unit fails, based on the assist data acquired by communication with the server, updating the stored assist data and storing the resulting assist data in the storage unit.

16. A GPS positioning terminal comprising:
a storage unit for storing therein assist data for GPS positioning;
a determination unit for determining whether stored assist data that is the assist data stored in the storage unit is valid or invalid;
a non-communication-type positioning unit for, when the stored assist data is determined to be valid, based on the stored assist data determined to be valid without communicating with a server on a network, performing GPS positioning;
a communication-type positioning unit for, when the stored assist data is determined to be invalid, based on assist data acquired by communication with the server, performing GPS positioning; and
an updating unit for, when the GPS positioning by the non-communication-type positioning unit or the communication-type positioning unit succeeds, based on a result of the positioning, updating the stored assist data and storing the resulting assist data in the storage unit and, when the GPS positioning by the non-communication-type positioning unit or the communication-type positioning unit fails, based on the assist data acquired by communication with the server, updating the stored assist data and storing the resulting assist data in the storage unit.
